(19) United States
(12) Patent Application Publication
(10) Pub. No.: US 2023/0281775 A1
(43) Pub. Date: Sep. 7, 2023

(54) SPECTRAL RECONSTRUCTION FOR MULTISPECTRAL IMAGING

(71) Applicant: Schölly Fiberoptic GmbH, Denzlingen (DE)

(72) Inventors: Sébastien WEITBRUCH, Niedereshach (DE); Andreas HILLE, Villingen-Schwenningen (DE); Joachin JAUSS, Rheinhausen (DE)

(73) Assignee: Schölly Fiberoptic GmbH, Denzlingen (DE)

(21) Appl. No.: 18/155,811

(22) Filed: Jan. 18, 2023

(30) Foreign Application Priority Data
Jan. 28, 2022 (DE) 102022102017.7

(51) Int. Cl. G06T 5/50; G06V 10/141; G06T 19/00

(52) U.S. Cl. CPC G06T 5/50; G06T 19/006; G06V 10/141; G06T 2207/10024; G06T 2207/10036

(57) ABSTRACT

To improve the image quality and color authenticity of a white light image (5), which is sensorially acquired in the context of multispectral imaging, different sub-spectra (2) of a light spectrum (1) used for imaging are sensorially acquired either spatially separately or chronologically separately from one another and in the computation of the white light image (5), a secondary spectrum (4) of these sub-spectra (2) is taken into consideration which is acquired separately (chronologically or spatially) from a main spectrum (3) of the light spectrum (1). This approach offers the advantage that an additional spectral component (6), which is based on the separately acquired secondary spectrum (4), can thus be injected as needed into the white light image (5) or extracted therefrom, to thus achieve the desired improved image quality.

### CROSS-REFERENCE TO RELATED APPLICATIONS

This application claims the benefit of German Patent Application No. 10 2022 102 017.7, filed Jan. 28, 2022, which is incorporated herein by reference as if fully set forth.

### TECHNICAL FIELD

The invention relates to a method for multispectral imaging, in which a light spectrum is used for imaging and is sensorially acquired for this purpose, which consists of at least two sub-spectra, which typically complement one another or can display a certain spectral overlap. The at least two sub-spectra are separately acquired. One of the acquired sub-spectra forms a main spectrum in this case, from which a white light image is computed.

The invention can thus also be used for an associated image processing method, in which at least two image signals are generated, which relate to or have different spectral ranges, wherein the spectral ranges can complement one another or can have a certain spectral overlap.

The invention furthermore relates to an associated image recording device, using which such a method may be practically applied.

### BACKGROUND

Multispectral imaging methods are known and are used, for example, in medical applications, in order to provide a visual image with augmented information (augmented information / augmented view) in terms of a so-called spectrum reconstruction (reconstruction of the imaging spectrum). Such augmented information can be, for example, the spatial distribution of an oxygen saturation in the tissue or also local fluorescence signals of fluorescent dyes using which certain tissue types or, for example, blood vessels can be made visible or also other infrared (IR) signals.

Multispectral imaging is therefore an advanced imaging technology which enables more items of information to be obtained from an image than the human eye is capable of. To achieve this, a camera system acquires the various sub-spectra of the observed scene separately. An analysis of these various sub-spectra by comparison or the like can then supply augmented information, which can be merged with the typical visual content, as results in the white light imaging. Depending on the situation, for example, various acquired sub-spectra have to be merged again in order to supply the observer with the best possible, thus the most true-color possible, video image stream, ideally independently of whether they currently have the augmented information displayed or not.

In previously known approaches for multispectral imaging, an acquired spectrum, which is thus used for imaging, is typically divided into various sub-spectra for further analysis, one of which typically represents a main spectrum, which is used for the visual reproduction of the scene by means of a white light image (real view/white light imaging = WLI). The remaining sub-spectra, which are often acquired spatially separately, are solely analyzed separately to supply the user with augmented information. The sub-spectra are thus exclusive, however, i.e., the separately acquired secondary spectra are typically absent in the white light image. This has the result that upon the creation of a real view by means of the computed white light image, a part of the light energy is absent for the observer. This often results in an increase of signal noise and/or a reduction of the color purity of the white light image, both of which are undesired.

In contrast, if the various sub-spectra are acquired using the same image sensor, but in chronological succession, thus chronologically separately from one another, it frequently occurs that a specific sub-spectrum (for example, in the IR or NIR wavelength range) contaminates the real view, for example if the spectra partially chronologically overlap; this then typically also results in a reduction of the color purity or the image quality in general. Beam splitters can additionally also be used in such approaches in order to improve a spectral separation.

### SUMMARY

Proceeding therefrom, the invention is based on the object of improving the quality of the image representation in such methods.

To achieve this object, one or more of the features according to the invention as disclosed herein are provided in a multispectral imaging method. In particular, it is therefore provided according to the invention, to achieve the object in an imaging method of the type mentioned at the outset, that at least one separately acquired secondary spectrum of the sub-spectra is used to extract at least one additional spectral component from the white light image and/or to inject it into the white light image (in particular a further additional spectral component).

In other words, according to the invention a spectral signal component which was sensorially acquired separately thus can be at least partially added to the white light image or removed therefrom, in particular to thus improve the image quality of the white light image and thus the visual impression for the user.

One essential advantage of this approach is that the white light image can thus be reconstructed or reproduced more realistically and/or with improved color authenticity and/or with improved image quality. The invention thus enables the best possible spectral reconstruction of a real observed scene to be enabled at every point in time. The invention supplies a solution approach for both stated problems mentioned at the outset (chronologically separated or simultaneous recording of the sub-spectra) and in this case can improve the image quality, increase the color purity of the white light image, and also reduce the signal noise. Nonetheless, augmented information, which goes beyond the image content of the white light image or the human visual impression, can also still be supplied.

The additional spectral component can be in particular a spectral image component or a spectral image signal component of the white light image.

The extraction or injection can be carried out, for example, by means of a weighting, so that the respective additional spectral component / the respective sensorially acquired image signal, which is based on the at least one secondary spectrum, can also be only partially added or removed.

The white light image can typically already be provided as a digital file and/or can be computed from corresponding sensor signals, in particular with application of a color transformation.

The light spectrum used for imaging is essentially determined by the spectrum of the illumination light used for the imaging; however, it can also contain wavelengths which are not contained in the illumination light, such as IR fluorescent light which is only generated by irradiation of fluorophores using the illumination light.

The light source used for the imaging can be selected within a large wavelength spectrum, depending on the application, for example, only in the visible range, or also having components in the NIR, in the UV, or even beyond the IR range.

The method presented here is thus directed to using N different sub-spectra for multispectral imaging, in particular to obtain items of augmented image information, and to enable a high quality of the (classic) white light imaging at the same time.

According to the invention, the object can also be achieved by further advantageous embodiments described below and in the claims.

For example, the at least two sub-spectra can be sensorially acquired either simultaneously both spatially separately or chronologically separately, in particular by use of a time multiplexing method and/or using only one image sensor (this can be a color image sensor or a monochromatic image sensor). Both of these approaches are explained in more detail later on the basis of exemplary embodiments.

Furthermore, the at least one additional spectral component can be evaluated separately from the white light image, in order to generate augmented image information, in particular an augmented image component. This augmented image information can be added to the white light image, for example, as an overlay, or it can be utilized / analyzed separately from the white light image.

The white light image can preferably be computed from at least two spectrally different image signals of a color image sensor in an image reconstruction.

Furthermore, the at least one secondary spectrum, which can be acquired either using the same color image sensor or using a separate image sensor, can be used to obtain / compute augmented image information. This augmented image information can then preferably be overlaid on the white light image, which can be carried out in particular by means of a false color representation. The user can thus also spatially assign the augmented image information on the basis of the white light image, which reflects the visual impression of the user. The described procedure can thus in particular be used to implement an augmented reality view of the white light image together with the augmented image information.

The described approach can thus amount to generating a typical white light image by means of white light processing and furthermore obtaining augmented image information by sensorially acquiring and evaluating at least one secondary spectrum, which can be used as “augmented information” to upgrade the white light image. The additional spectral component which is added to the white light image or extracted therefrom can in particular be based on the secondary spectrum here, from which the augmented image information was obtained; however, the additional spectral component can also alternatively or additionally also be based on a further (sensorially acquired) secondary spectrum.

In an image reconstruction of the white light image, in particular the one described above, at least one additional image signal can thus be taken into consideration, which was or is acquired (in particular simultaneously with the at least two spectrally different image signals of the color image sensor) using a second separate, in particular monochromatic image sensor. This spatially separate acquisition can take place in particular using an optical filter. This is because the filter can, for example, from an input spectrum recorded by means of a recording optical unit, filter out a specific secondary spectrum and provide it for more detailed analysis. In such an approach having spatially separate acquisition of the at least one secondary spectrum, it is preferred if the at least one additional spectral component is added to the white light image, in particular at least partially and/or in weighted form, by considering the additional image signal. This is because the color authenticity of the white light image can thus be increased. This approach can be understood as an additive spectrum reconstruction, in which the white light image also depicts the added special component.

Alternatively to the above-explained approach, at least one additional image signal can also be taken into consideration in the image reconstruction of the white light image, which was sensorially acquired at a different point in time (in particular using the color image sensor, using which the white light image is recorded) than at least two spectrally differing image signals acquired using the color image sensor, on which the white light image is based. In other words, the color image sensor is then alternately used at different points in time for recording the main spectrum and the at least one secondary spectrum (time multiplexing method). In such an approach using chronologically separate acquisition of the at least one secondary spectrum, it is preferred if, by taking into consideration the additional image signal, the at least one additional spectral component is (at least partially) removed from the white light image. This approach can thus be understood as subtractive spectrum reconstruction, in which the white light image no longer depicts/contains the removed or at least attenuated spectral component, or only does so in attenuated form. This approach suggests itself in particular if the additional spectral component corrupts the white light image.

The main spectrum can be acquired as stated by means of a color image sensor. This can be designed in particular as an RGB sensor.

In contrast, the at least one secondary spectrum can be acquired using a monochromatic image sensor. In particular, for example, two secondary spectra can thus each be acquired using one (assigned) separate monochromatic image sensor in each case. Such a simultaneous recording of numerous sub-spectra suggests itself for example if only little light is available and a live video stream having augmented information is to be provided simultaneously.

The main spectrum and the at least one secondary spectrum can thus each be recorded spatially separately from one another and/or simultaneously by an assigned image sensor in each case.

Furthermore, (at least) two secondary spectra can each be recorded spatially separated from one another and/or simultaneously by one assigned, in particular monochromatic image sensor in each case.

In contrast, the alternative multiplexing approach described for this purpose provides that the at least two sub-spectra are recorded in chronological succession by one color image sensor, in particular with application of a time multiplexing method. The respective acquired sub-spectra can display, at least temporarily, a chronological overlap. This can occur, for example, if fluorescent light is observed, which is emitted with a certain chronological variance (in reaction to a previously occurring excitation using illumination light). To take into consideration such chronological overlaps, which can have negative effects on the image quality, the above-described subtractive spectrum reconstruction can be used.

The main spectrum and the at least one secondary spectrum can complement one another to form the light spectrum used for imaging, for example, if all sub-spectra are solely obtained by filtering a light spectrum which is recorded or collected by means of an optical unit, in particular an illumination light spectrum. In such a case, the computed white light image can thus reproduce the entire sensorially acquired light spectrum, for example, if the described additive spectrum reconstruction is applied.

Depending on the application and/or design of the image recording device used for image recording, however, the actual sensorially acquired main spectrum can also have a spectral overlap with the at least one secondary spectrum. This can occur, for example, if the main spectrum and the secondary spectrum are recorded in chronological succession (multiplexing approach), but nonetheless chronologically overlap, so that the secondary spectrum (for example IR light) is recorded in a specific time window together with other (for example visible) wavelengths as the main spectrum. If the described subtractive spectrum reconstruction is applied in such a case, it is thus advantageous if the additional spectral component extracted from the white light image is just in the spectral overlap. This is because in this way the corruption of the white light image by wavelengths from the secondary spectrum can be avoided. In other words, in such cases wavelengths from the secondary spectrum can thus be sensorially acquired as an undesired part of the main spectrum, but can subsequently be removed again from the white light image by the subtractive spectrum reconstruction.

In order to practically implement the above-described method, for example, it can be provided that the main spectrum and the at least one secondary spectrum are acquired by a common optical unit (of an image recording device) and are subsequently spatially separated from one another by means of beam splitting / a beam splitter and/or by means of optical filters. This approach may be implemented particularly compactly with the aid of beam splitters and optical thin-film filters applied thereon.

In contrast, an alternative approach thereto provides that an illumination light spectrum of an illumination light which is used for imaging is chronologically varied, for example, alternately or quasi-continuously. The main spectrum and the at least one secondary spectrum can thus be chronologically separated from one another. This second approach can be implemented, for example, using a spectrally tunable light source, using two alternately operated light sources, or, for example, with the aid of a rotating filter wheel, which chronologically varies the illumination light incident on the observed scene.

A further preferred embodiment of the method provides that a computation of the white light image, in particular the one described in detail above, comprises a color balance, in particular a white balance, which takes into consideration the additional spectral component based on the at least one secondary spectrum.

A computation of the (final) white light image, in particular the one explained above, can preferably be implemented by means of a matrix transformation, which processes as an input variable at least one color vector, which describes the at least one additional spectral component. The at least one color vector can particularly preferably additionally be used in this case to compute augmented image information. This augmented image information can preferably then also be displayed to the user (in particular live).

For example, a color matrix can be formed which weights the respective image signals as color vectors differently, in order to compute the final white light image therefrom. A white light image therefore does not necessarily have to be computed beforehand, before the at least one additional spectral component, which is based on the secondary spectrum, is injected into the white light image or extracted therefrom; rather, the step of extracting / injecting the at least one additional spectral component can be carried out during an initial computation of the white light image.

Finally, to achieve the object mentioned at the outset, an image recording device for multispectral imaging is also proposed. This device comprises an image processor, which is distinguished in that the image processor is configured to compute a white light image from sub-spectra sensorially acquired using the image recording device (or from image signals which are associated/derived therefrom), specifically using a method according to one of the claims directed to an image recording method and/or as described here.

Depending on the approach followed, the image recording device can have, as described above, a single color image sensor or a color image sensor and at least one separate, in particular monochromatic image sensor. Moreover, the image recording device can have the described corresponding means for beam splitting and/or spectral filters, in order to acquire the individual sub-spectra spatially separately.

### BRIEF DESCRIPTION OF THE DRAWINGS

The invention will now be described in more detail on the basis of exemplary embodiments, but is not restricted to these exemplary embodiments. Further embodiments of the invention can be obtained from the following description of a preferred exemplary embodiment in conjunction with the general description, the claims, and the drawings.

In the following description of various preferred embodiments of the invention, elements corresponding in their function receive corresponding reference numerals even with differing design or shaping.

In the figures:

FIG. 1 shows a schematic view of an approach according to the invention for spatially separate acquisition of multiple sub-spectra,

FIG. 2 shows a schematic view of a further approach according to the invention for spatially separate acquisition of multiple sub-spectra,

FIG. 3 shows a schematic view of an image recording device according to the invention,

FIG. 4 shows a schematic view of an approach according to the invention for chronologically separate acquisition of multiple sub-spectra,

FIG. 5 shows a schematic view of a further approach according to the invention for chronologically separate acquisition of multiple sub-spectra, and

FIG. 6 shows a schematic view of a further approach according to the invention for spatially separate acquisition of multiple sub-spectra.

### DETAILED DESCRIPTION

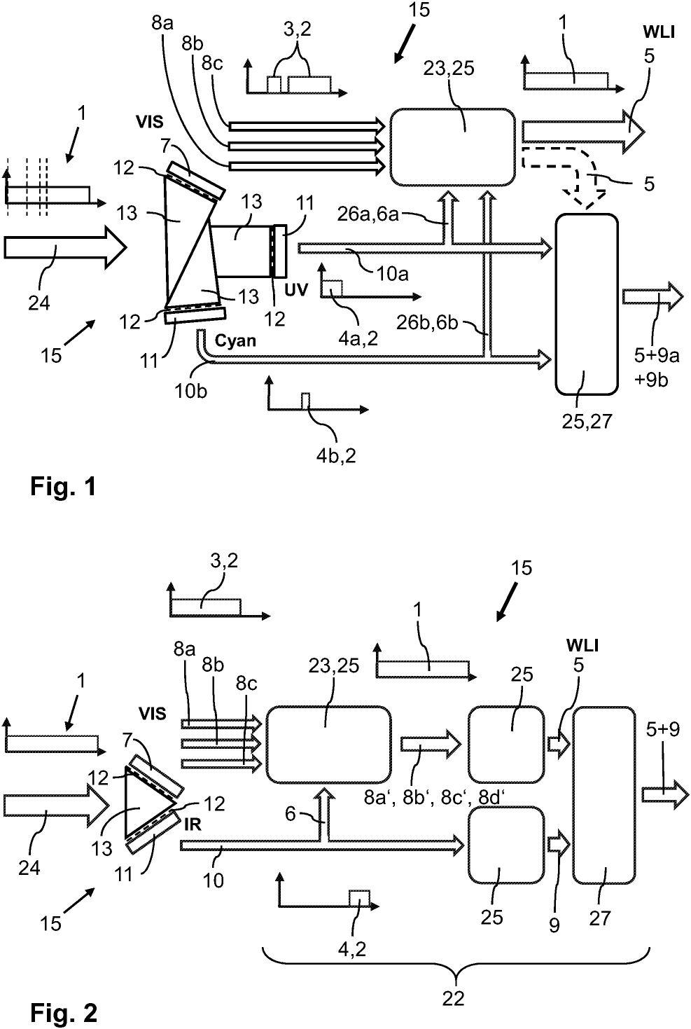

FIG. 1 shows a schematic diagram to illustrate an imaging method according to the invention and an image recording device 15 according to the invention. The device 15 has a color image sensor 7 and two further monochromatic image sensors 11. An optical filter 12 is arranged in front of each of the three image sensors 7, 11, wherein an input spectrum 24 recorded by means of an optical unit of the image recording device 15 is conducted with the aid of multiple beam splitters 13 onto the respective optical filters 12 and the image sensors 7, 11 arranged downstream.

As is apparent on the basis of the spectra sketched by means of arrow diagrams in FIG. 1, the respective filters 12 are designed so that the left monochromatic image sensor 11 selectively acquires cyan-colored visible light from the input spectrum 24, while the second monochromatic image sensor 11 selectively acquires UV wavelengths. The optical filter 12, which is assigned to the color image sensor 7, in contrast, is designed so that the color image sensor 7 acquires all other wavelengths from the input spectrum 24. Three different sub-spectra 2 are thus sensorially separately acquired using the three image sensors 7, 11, wherein these three sub-spectra 4a, 4b, and 3 complement one another to form the light spectrum 1 used for imaging, which is shown in the left diagram, wherein the dashed lines in the diagram identify the respective boundary wavelengths of the optical filters 12.

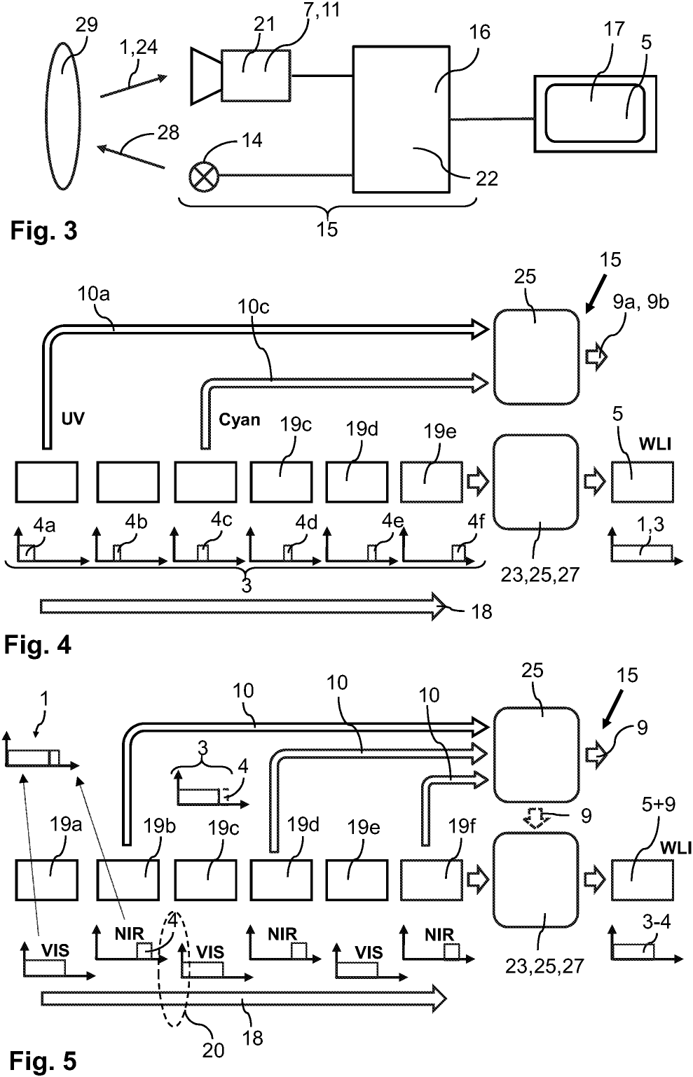

As FIG. 3 illustrates, during the imaging, an object 29 to be observed is irradiated using a light source 14 of the device 15, which emits a specific illumination light spectrum 28. The input spectrum 24 recorded by the video camera 21 of the image recording device 15, which corresponds to the light spectrum 1 used for the imaging, however, can contain still further wavelengths in addition to the illumination light spectrum 28, for example, if the observed scene 29 contains fluorophores, which are excited by the illumination light 28 and emit fluorescent light, which is acquired using the video camera 21.

As FIG. 1 illustrates, the image signals 10a and 10b, which are supplied by the two monochromatic image sensors 11, are each subjected to signal processing in the bottom right signal processor 25, in order to obtain augmented image information 9. For example, a location distribution of an oxygen saturation of tissue may be ascertained from these two image signals 10a, 10b, which is observed using the image recording device 15.

In contrast, the color image sensor 7, which sensorially acquires the main spectrum identified by reference numeral 3, is used to enable white light imaging (WLI), which supplies a visual impression of the observed scene 29 to the user. However, the color image sensor 7 in particular does not acquire the two secondary spectra 4a and 4b in the UV and cyan wavelength range, which are sensorially acquired by the two monochromatic image sensors 11. To nonetheless enable the most realistic possible white light imaging, the color authenticity of which is optimized and in which the signal noise is moreover minimal, two additional spectral components 6a and 6b, which are respectively based on the image signals 10a and 10b supplied by the two monochromatic image sensors 11, are injected into the final white light image 5 to be computed.

To compute the final white light image 5, for this purpose both the three image signals 8a, 8b, and 8c, which are supplied by the color image sensor 7 designed as an RGB sensor, and the two image signals 10a and 10b, which are supplied by the two monochromatic image sensors 11, are processed by a signal processor 25. More precisely, the white light image 5 is computed by means of a matrix transformation 23, which as the input variable processes two color vectors 26a and 26b, which describe the two additional spectral components 6a and 6b, which are acquired by the two monochromatic image sensors 11, thus the UV light component and the cyan light component. Due to the consideration of these two spectral components 6a and 6b in the matrix transformation 23, they are thus added to the white light image 5, so that as a result the white light image 5 again reproduces the entire light spectrum 1 used for the imaging, as indicated by means of the top right schematic spectrum.

It is furthermore apparent in FIG. 1 that the white light image 5 thus computed is also supplied to the signal processor 25 arranged on the far right, which also processes the two image signals 10a and 10b of the two monochromatic image sensors 11 as input variables. This signal processor 25 overlays the augmented image information 9 computed from the two image signals 10a and 10b on the already previously computed white light image 5, so that in addition to the white light image 5 improved in its color authenticity, an augmented reality view of the white light image 5 can be displayed to the user if needed together with the augmented image information 9. For example, the augmented image information 9, thus, for example, the local blood oxygen saturation, can be overlaid on the white light image 5 by means of a false color representation.

FIG. 2 shows a further example of how a multispectral imaging method according to the invention can be implemented: In this case, a secondary spectrum 4 is again sensorially acquired spatially separately by means of a monochromatic image sensor 11, wherein an upstream optical filter 12 filters out visible wavelengths. By means of a color sensor 7, which also has an upstream filter 12, which in particular filters out IR wavelengths (IR cutoff filter), a color image is recorded in a typical manner, which is described by the three image signals 8a, 8b, 8c.

As in FIG. 1, a spectrum reconstruction according to the invention is also implemented in the example of FIG. 2, since the left signal processor 25, in addition to the three image signals 8a, 8b, and 8c of the color image sensor 7, also takes into consideration the image signal 10 generated separately using the monochromatic image sensor 11, which reflects the IR content of the observed scene 29. However, in this application the IR component of the light recorded using the image recording device 15 acts as an interference signal for the white light imaging. This can occur, for example, if the IR component cannot be filtered out cleanly and is thus at least partially also acquired by the color image sensor 7. As a result, for example, the color saturation in the white light image can be reduced. In this case, it is helpful to electronically eliminate the IR light also acquired by the color image sensor 7 subsequently, in that this signal component is computed out of the white light image by means of a subtractive spectrum reconstruction.

For this purpose, the left signal processor 25 in FIG. 2 (or the first one in the signal chain) implements a color balance, which takes into consideration the additional spectral component 6, which is based on the secondary spectrum 4 sensorially acquired by means of the monochromatic image sensor 11. As shown in FIG. 2, the left signal processor 25 thus outputs adapted image signals 8a′, 8b′, 8c′, 8d′. Building on the completed color balance, the following (right) signal processor 25 then computes from these signals 8a′, 8b′, 8c′, 8d′ a white light image 5, in which the additional spectral (IR) component 6 is no longer included (or is only still included in very attenuated form). As a result, the white light image 5 thus has an improved image quality and color authenticity; in particular, the color saturation of the white light image 5 can be improved.

In contrast, the bottom image processor 25 in FIG. 2 evaluates the additional spectral component 6 separately from the white light image 5, to generate augmented image information 9 therefrom. As indicated in FIG. 2 by means of the block arrows, this additional image information 9 can then be added subsequently to the (optimized) white light image 5 in the context of an image overlay 27.

In the two examples of FIGS. 1 and 2, at least one additional image signal 10 is thus taken into consideration in each case in the image reconstruction of the white light image 5, which is acquired simultaneously to at least two spectrally different image signals 8a and 8b of the color image sensor 7 using a separate image sensor 11, specifically while employing an optical filter 12. The respective additional spectral component 6/6a/6b is (proportionally) added here in each case to the white light image 5 or (proportionally) subtracted from the white light image 5. This addition/extraction of the additional spectral component 6 can in particular comprise a weighting in the context of the matrix transformation 23 or can be implemented by such a weighting. In the case of a subtractive spectrum reconstruction, the weighting will accordingly assume negative values; in contrast, it will assume positive values in the case of an additive spectrum reconstruction.

The two examples of FIGS. 4 and 5, in contrast, show examples of multispectral imaging methods according to the invention, in which multiple sub-spectra 2 of a light spectrum 1 used for imaging are acquired chronologically separately from one another, specifically with the aid of a single image sensor (thus spatially jointly).

In the example of FIG. 5, the illumination light spectrum 28, using which the scene 29 to be observed is illuminated, is alternately chronologically varied. For this purpose, illumination is alternately carried out using visible wavelengths (VIS) and using wavelengths in the near-infrared range (NIR). Accordingly, a single employed color image sensor 7 records the visible wavelengths at certain points in time (single images 19a and 19c) and the NIR light at points in time differing therefrom (single images 19b and 19d). At different points in time (single images 19b, 19d, 19f), the color image sensor 7 thus produces image signals 10 from which the upper signal processor 25 can compute augmented image information 9.

For the white light imaging, in contrast, in principle the single images 19a, 19c, and 19e are to be used which are recorded at the points in time when the visible illumination is just incident on the scene. Since the NIR illumination is used for fluorescent light imaging, however, in which the emission points of time of the fluorescent light cannot be accurately monitored, it can occur that the NIR light will also be recorded by the image sensor 7 when actually just the visible illumination is incident on the scene. In other words, there is then thus a time overlap 20 between the secondary spectrum 4 and the sub-spectrum of the visible wavelengths, which together make up the light spectrum 1 used for imaging.

It can thus occur in the example of FIG. 5 that, for example, during recording of the single image 19c, the main spectrum 3 sensorially acquired using the image sensor 7 at this point in time contains not only visible wavelengths from a first sub-spectrum 2 of the light spectrum 1, but rather also IR wavelengths from the secondary spectrum 4, which corrupt the white light imaging in this case, however. To remove these interfering IR signal components from the white light image 5 or at least attenuate them, the secondary spectrum 4 acquired sensorially chronologically separately is used to remove the associated (undesired) and additional spectral IR component 6 from the white light image 5.

To implement this subtractive spectrum reconstruction, the bottom signal processor 25 in FIG. 5 is configured so that it also processes the image signals 10 recorded at differing points in time by means of a matrix transformation 23 during the computation of the white light image 5 and thus also takes them into consideration, to thus (substantially) extract the undesired spectral component 6, which is based on the NIR light, from the white light image 5. Subsequently (as already described above), the augmented image information 9 computed from the (sensorially separately acquired) secondary spectrum 4 can be added to the computed white light image 5 (now having improved color authenticity) in the context of an image overlay 27.

In the example of FIG. 4, the illumination light spectrum 28 of the illumination light source used for illumination is chronologically changed not alternately, but rather continuously. As the time axis 18 and the individual diagrams of the sub-spectra 2 arranged above it indicate, in this case the illumination light spectrum 28 is chronologically varied quasi-continuously, so that a large wavelength range is covered, which is implementable, for example, using a tunable illumination light source. Only a single image sensor 7, which records the various single images 19, is also required in the example of FIG. 4. By taking into consideration the image signals 10a and 10c, which are based on the secondary spectra 4a and 4c sensorially acquired at different points in time using the image sensor 7, the signal processor 25 can compute at least one augmented item of information 9, which is based on an associated spectral component 6a (UV light) or 6c (cyan-colored visible light).

The bottom signal processor 25 in FIG. 4 now takes into consideration all image signals 10 which have been obtained at different points in time using the image sensor 7 (and correspond to the respective recorded single images 19) and computes therefrom a white light image 5 with high spectral resolution, which thus comprises the entire light spectrum 1 used for imaging. In other words, the imaging method according to the invention is thus used here for an additive spectrum reconstruction, in order to obtain a high-resolution and true-color white light image 5 at the same time in addition to the valuable augmented image information 9. Of course, the computed augmented information 9 can also finally be overlaid (not shown in FIG. 4) on the white light image 5 computed in parallel in the example of FIG. 4. In the example of FIG. 4, the entire light spectrum 1 can thus be understood as the main spectrum on which the white light imaging is significantly based, in contrast to the examples of FIGS. 1 and 2, where the main spectrum 3 only makes up a part of the light spectrum 1 used for imaging.

In the examples of FIGS. 4 and 5, the respectively acquired main spectrum 3 thus displays a spectral overlap (at least temporarily) with a chronologically separately acquired secondary spectrum 4. In the example of FIG. 5, the spectral component 6 (namely the NIR light), which is extracted from the white light image 5, is just in the spectral overlap. In contrast, in the example of FIG. 4, all sensorially acquired spectral components 6 which originate from the respective secondary spectra 4 form the main spectrum 3, on which the white light image 5 is based.

In the examples of FIGS. 1, 2 and 4 and 5, both the main spectrum 3 and the at least one secondary spectrum 4 are each acquired by a common optical unit of the video camera 21; however, while in the examples of FIGS. 1 and 2 the individual sub-spectra 3, 4 are spatially separated from one another by means of a beam splitter 13 and optical filter 12, in the example of FIG. 4, all six secondary spectra 4a to 4f are recorded chronologically separately from one another but using the same color image sensor 7, and in the example of FIG. 5, the main spectrum 3 is also sensorially acquired chronologically separately from the NIR secondary spectrum 4 but using the same color image sensor 7.

Finally, it is also to be noted that the signal processors 25 shown in the individual exemplary embodiments can each be implemented by a corresponding image processor 22, which can be implemented either directly in the video camera 21 or, for example, in the control unit 16 of the image recording device 15 (cf. FIG. 3).

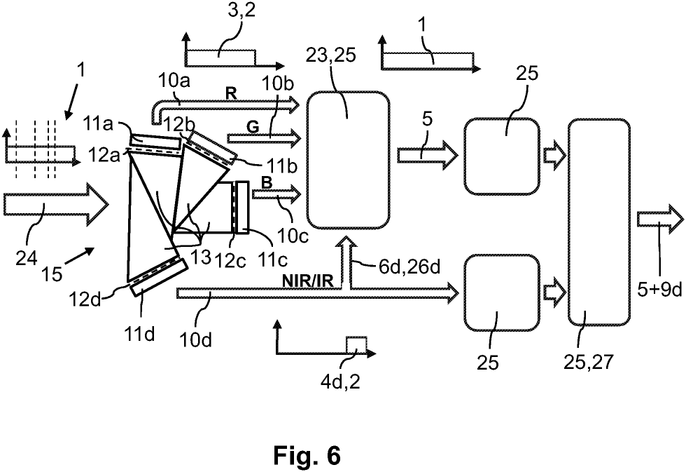

The exemplary embodiment of FIG. 6 is similar to that of FIG. 1, but a total of four beam splitters 13 are used here to spatially divide the incident input spectrum 24, and the color image sensor 7 was replaced by three monochromatic image sensors 11a, 11b, and 11c. Therefore, the image recording device 15 of FIG. 6 comprises a total of four monochromatic image sensors 11a, 11b, 11c, and 11d, which each have an associated optical filter 12a, 12b, 12c, 12d, the transmission properties of which are selected differently. The filters 12a, 12b, 12c can preferably be selected for this purpose (wherein the respective transmission windows of the filters can partially overlap) so that the entire visible wavelength range can be acquired using the three image sensors 11a, 11b, and 11c.

In the example of FIG. 6, the image sensor 11a acquires visible red wavelengths, the image sensor 11b acquires visible green wavelengths, the image sensor 11c acquires visible blue wavelengths, and the image sensor 11d acquires invisible infrared wavelengths. As a result, a red (R), a green (G), a blue (B), and an infrared (IR) color channel are thus implemented, wherein a white light image 5 can be computed from the first three channels R/G/B. The main spectrum 3 is thus already obtained here from the three image signals 10a, 10b, and 10c by additive spectrum reconstruction.

The NIR component (secondary spectrum 4d), in contrast, is evaluated separately to compute an IR image from the image signal 10d. The associated spectral component 6d is also taken into consideration in the context of an additive spectrum reconstruction by the signal processor 25, however, which computes the white light image 5 thus improved in its color authenticity, in terms of multispectral imaging. As a result, using this device / this approach, a true-color white light image 5 and additionally augmented image information 9d can also thus be obtained, which reflects the spatial distribution of the IR component of the recorded scene and can be overlaid on the white light image 5.

In summary, to improve the image quality and color authenticity of a white light image 5, which is sensorially acquired in the context of multispectral imaging, it is proposed that different sub-spectra 2 of a light spectrum 1 used for imaging are sensorially acquired either spatially separately or chronologically separately from one another and that in the computation of the white light image 5, a secondary spectrum 4 of these sub-spectra 2 is taken into consideration, which is acquired separately (chronologically or spatially) from a main spectrum 3 of the light spectrum 1. This approach offers the advantage that thus an additional spectral component 6, which is based on the separately acquired secondary spectrum 4, can as needed be injected into the white light image 5 or extracted therefrom, to thus achieve the desired improved image quality.

| | List of Reference Numerals |
|---|---|
| 1 | light spectrum |
| 2 | sub-spectrum (of 1) |
| 3 | main spectrum (of 1 or 2) |
| 4 | secondary spectrum (of 1 or 2, typically spectrally narrower than 3) |
| 5 | white light image |
| 6 | spectral component, in particular image signal component |
| 7 | color image sensor |
| 8 | image signal (of 7) |
| 9 | augmented image information (augmented information) |
| 10 | image signal (of 7 or of 11) |
| 11 | monochromatic image sensor |
| 12 | optical filter |
| 13 | beam splitter |
| 14 | light source |
| 15 | image recording device, in particular endoscopic image recording system |
| 16 | control unit |
| 17 | monitor |
| 18 | time axis |
| 19 | single image (in particular having spectrally restricted image information) |
| 20 | chronological overlap |
| 21 | video camera |
| 22 | image processor (of 15) |
| 23 | matrix transformation |
| 24 | input spectrum (recorded by means of optical unit of 15) |
| 25 | signal processor |
| 26 | color vector |
| 27 | image overlay / overlay (of 5 and 9) |
| 28 | illumination light spectrum |
| 29 | observed scene / object |

1. A method for multispectral imaging, comprising:
sensorially separately acquiring at least two sub-spectra (2) of a light spectrum (1) used for imaging;
computing a white light image (5) from an acquired main spectrum (3) of the at least two sub-spectra (2); and
using at least one separately acquired secondary spectrum (4a, 4b) of the sub-spectra (2) for at least one of a) extracting at least one additional spectral component (6a, 6b) from the white light image (5) or b) injecting the at least one additional spectral component (6a, 6b) into the white light image (5).

2. The method as claimed in claim 1, further comprising at least one of reconstructing or reproducing the white light image (5) at least one of more realistically or with improved color authenticity.

3. The method as claimed in claim 1, further comprising the at least two sub-spectra (2) being at least one of a) sensorially acquired simultaneously but spatially separately, or b) sensorially acquired chronologically separately.

4. The method as claimed in claim 1, further comprising evaluating the at least one additional spectral component (6a, 6b) separately from the white light image (5), to generate augmented image information (9).

5. The method as claimed in claim 1, further comprising at least one of a) computing the white light image (5) from at least two spectrally different image signals (8a, 8b, 8c) of a color image sensor (7) in an image reconstruction, or b) using the at least one secondary spectrum (4a, 4b) to obtain augmented image information (9) that is overlaid on the white light image (5) to provide an augmented reality view of the white light image (5) together with the augmented image information (9).

6. The method as claimed in claim 5, further comprising during an image reconstruction of the white light image (5), taking into consideration at least one additional image signal (10), which was or is acquired using a second separate, image sensor (11), and by considering the additional image signal (10), at least partially adding the at least one additional spectral component (6a, 6b) to the white light image (5).

7. The method as claimed in claim 6, wherein the at least one additional image signal (10) is acquired simultaneously to the at least two spectrally differing image signals (8a, 8b, 8c) of a color image sensor (7) used for acquiring the at least two sub-spectra (2) of the light spectrum (1).

8. The method as claimed in claim 4, further comprising during image reconstruction of the white light image (5), taking into consideration at least one additional image signal (10) which was sensorially acquired at a different point in time than at least two spectrally different image signals (8a, 8b, 8c) acquired using a color image sensor (7), on which the white light image (5) is based.

9. The method as claimed in claim 8, further comprising for considering the at least one additional image signal (10), at least partially removing the at least one additional spectral component (6a, 6b) from the white light image (5).

10. The method as claimed in claim 1, further comprising acquiring a main spectrum (3) using a color image sensor (7), and acquiring the at least one separately acquired secondary spectrum (4a, 4b) using a separate monochromatic image sensor (11).

11. The method as claimed in claim 10, further comprising recording each of the main spectrum (3) and the at least one secondary spectrum (4a, 4b) spatially separately from one another and/or simultaneously using a respective associated image sensor (7, 11).

12. The method as claimed in claim 10, further comprising recording two of the secondary spectra (4a, 4b) spatially separately from one another and/or simultaneously by a respective associated image sensor (11a, 11b).

13. The method as claimed in claim 10, further comprising recording at least two sub-spectra (3, 4) in chronological succession by the color image sensor (7).

14. The method as claimed in claim 10, wherein the main spectrum (3) and at least one said secondary spectrum (4a, 4b) complement one another to form the light spectrum (1) used for imaging, or the acquired main spectrum (3) has a spectral overlap (21) with the at least one secondary spectrum (4a, 4b).

15. The method as claimed in claim 10, wherein the main spectrum (3) and the at least one secondary spectrum (4a, 4b) are acquired by a common optical unit and are subsequently spatially separated from one another by at least one of a beam splitter (13) or optical filters (12).

16. The method as claimed in claim 10, wherein an illumination light spectrum (28) of illumination light used for imaging is chronologically varied, and the main spectrum (3) and the at least one secondary spectrum (4a, 4b) are thus chronologically separated from one another.

17. The method as claimed in claim 1, wherein a computation of the white light image (5) comprises a color balance which takes into consideration the additional spectral component (6a, 6b) based on the at least one secondary spectrum (4a, 4b).

18. The method as claimed in claim 1, further comprising implementing the computation of the white light image (5) by a matrix transformation (23), which processes at least one color vector (26) as an input variable, which describes the at least one additional spectral component (6a, 6b).

19. The method as claimed in claim 18, wherein the at least one color vector (26) is additionally used to compute augmented image information (9).

20. An image recording device (15) for multispectral imaging, comprising: an image processor (22) configured to carry out the method according to claim 1 to compute the white light image (5) from the sub-spectra (2) sensorially acquired using the image recording device (15) or associated image signals (10).
